(19) United States
(12) Patent Application Publication
(10) Pub. No.: US 2005/0260058 A1
(43) Pub. Date: Nov. 24, 2005

(54) Hex fastener

(76) Inventor: Alphonse G. Cassagne III, Grand Isle, LA (US)

Correspondence Address: DAVID L. RAY, ATTORNEY AT LAW, 2051 SILVERSIDE DRIVE, SUITE 205, BATON ROUGE, LA, 70808, US

(21) Appl. No.: 10/848,272

(22) Filed: May 18, 2004

(51) Int. Cl. F16B 23/00

(52) U.S. Cl. 411/402

(57) ABSTRACT

An externally threaded fastener having an externally threaded shank, a concave head connected to the shank and axially aligned with the shank, and a drive stud connected to the head and axially aligned therein.

### BACKGROUND OF THE INVENTION

1. Field of the Invention

The present invention relates to threaded fasteners. More particularly, the present invention relates to threaded fasteners having a hexagonal shaped wrench receiving portion.

2. Description of the Related Art

Externally threaded fasteners having a shank, an integral head or flange, and a hexagonal shaped drive stud extending upward from a flange connected generally perpendicular to the shank are known in the art. The hexagonal head is adapted to receive a wrench for driving the fastener into a plank to connect the plank to a joist.

However, such fasteners, when used to connect wooden planks to a deck or dock, suffer the disadvantage of the hexagonal heads extending upward from the top of a plank. Such protruding hexagonal heads can strike the shoes or feet of a person walking on the deck and cause the person to trip and possibly fall. Such fasteners may be countersunk with the result that the head of the fastener penetrates the surface of a plank forming a cylindrical hole which will fill with rain water and rot the plank in which the hole is formed. The holes formed by countersinking conventional hexagonal drive fasteners can be filled with putty or other filler to form a smooth surface on the plank receiving the fastener, but such a procedure is time consuming and costly.

Exemplary of the patents of the related art are the following: U.S. Pat. No. 6,443,681 B1; 6,254,326; 6,045,311; 5,609,454; 5,302,068; 4,759,672; 4,460,300; 1,040,568; 951,437; Japanese Patent JP9329117; and U.S. Patent Application Pub. No. U.S. 2003/0044257 A1.

### BRIEF SUMMARY OF THE INVENTION

In accordance with the present invention there is provided an externally threaded fastener having an externally threaded shank, a concave head connected to the shank and axially aligned with the shank, and a drive stud connected to the flange and axially aligned therein.

### BRIEF DESCRIPTION OF THE SEVERAL VIEWS OF THE DRAWINGS

FIG. 1 is an elevational view of the first embodiment of the invention;

FIG. 2 is a partly cut-away, expanded, cross-sectional taken along lines 2-2 view of FIG. 1;

FIG. 3 is a top, perspective view of FIG. 2

FIG. 4 is a cross-sectional view, partly cut-away view of the fastener of FIG. 1 screwed into a deck plank and a joist; and

FIG. 5 is an alternate embodiment of the fastener of the invention.

### DETAILED DESCRIPTION OF THE INVENTION

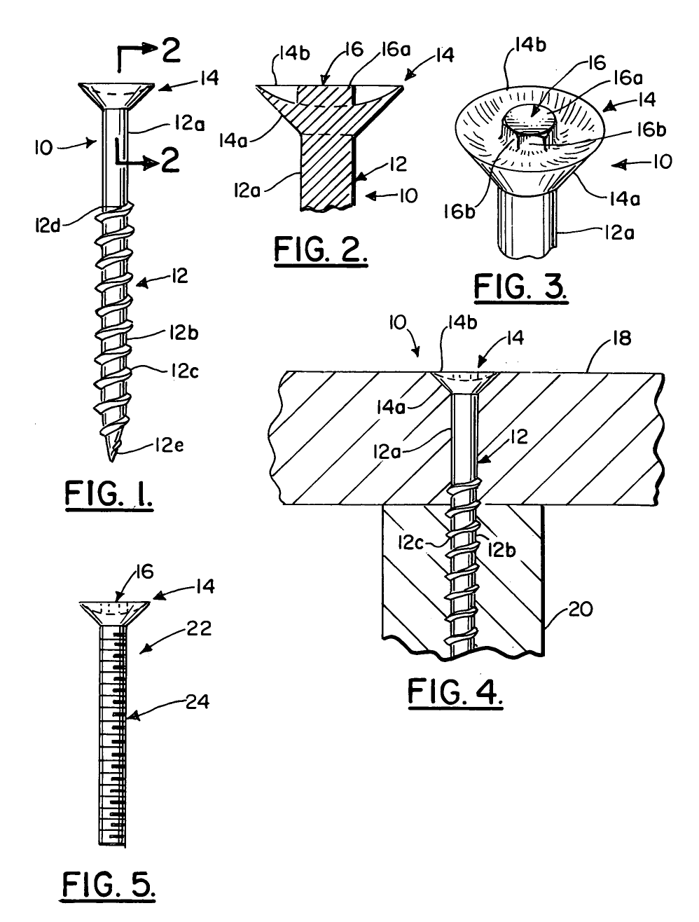

Referring now to the drawings, and in particular to FIGS. 1-4, the fastener of the invention is generally referred to by the numeral 10. Fastener 10 has a shank generally indicated by the numeral 12, an integral head or flange generally indicated by the numeral 14, and a wrench receiving drive stud generally indicated by the numeral 16 connected inside of head 14.

Shank 12 has an upper cylindrical portion 12a and a lower cylindrical portion 12b. Lower cylindrical portion 12b has a conventional wood screw thread 12c thereon which extends around the surface of lower cylindrical portion 12b from the top 12d of lower cylindrical portion 12b to the conical pointed bottom 12e of lower cylindrical portion 12b.

Head 14 is generally cup-shaped or concave with the open concave portion of head 14 facing upwardly from the top of upper cylindrical portion 12a of shank 12. Concave head 14 has an upwardly tapered or conical outer surface 14a terminating in an upper circular edge 14b which lies in a plane perpendicular to the longitudinal axis of shank 12. Conical outer surface 14a enables fastener 10 to be countersunk into a wooden or synthetic plank such as plank 18 shown in FIG. 4. As shown in FIG. 4, the upper circular edge 14b of head 14 is even with the surface of plank 18 and no portion of fastener 10 extends above the upper surface of plank 18.

Wrench receiving drive stud 16 is integrally formed with head 14 and is axially aligned therein. Preferably drive stud 16 is hexagonal in shape for receiving a common female hexagonal drive wrench to rotate fastener 10, although if desired, drive stud 16 could have a square shape or other desired shape. Drive stud 16 is completely contained within the concave portion of head 14 and has a planar top surface 16a which lies in the same plane as the upper circular edge 14b of head 14. Drive stud 16 has six generally rectangular intersecting flat sides 16b which form the preferred hexagonal exterior sides of drive stud 16. Furthermore, the diameter of the upper circular edge 14b of head 14 relative to the size of drive stud 16 is selected to enable a drive stud receiving wrench to be inserted into the concave portion of head 14 onto drive stud 16 to drive fastener 10 into a plank such as deck plank 18 shown in FIG. 4 and supporting deck joist 20. Thus, drive stud 16 is spaced apart from upper circular edge 14b sufficiently far enough to receive a drive stud receiving wrench for rotating fastener 10 and screwing fastener 10 into a plank.

Fastener 10 enables the fastening of deck or floor planks such as plank 18 to deck or floor joists such as joist 20 to achieve a smooth deck or floor surface without the protrusion of fasteners from the surface of the deck. When fastener 10 is screwed into deck plank 18 and deck joist 20 as shown in FIG. 4, upper circular edge 14b lies in the same plane as the upper surface of plank 18.

In FIG. 5 of the drawings is shown an alternate embodiment of the fastener of the invention generally indicated by the numeral 22. Fastener 22 has a shank generally indicated by the numeral 24, an integral head or flange generally indicated by the numeral 14 identical to the head or flange 14 shown in FIGS. 1-4 having wrench receiving drive stud identical to the wrench receiving drive stud 16 shown in FIGS. 1-4. Fastener 22 has a shank with bolt threads thereon rather than the screw thread 12c of fastener 10.

Although the preferred embodiments of the invention have been described in detail above, it should be understood that the invention is in no sense limited thereby, and its scope is to be determined by that of the following claims:

1. A threaded fastener comprising an externally threaded shank having an upper end and a lower end, a concave head connected to said upper end of said shank and axially aligned with said shank, said concave head having an open portion facing upward from said shank, said open portion of said concave head having a circular open edge lying in a plane perpendicular to the longitudinal axis of said threaded shank, and a drive stud adapted to receive a wrench for rotating said fastener, said drive stud being connected to said open portion of said concave head and axially aligned therein, said drive stud having a planar upper surface, said planar upper surface of said drive stud lying in substantially the same plane as said circular open edge, said drive stud being spaced apart from said circular open edge sufficiently far enough to receive a drive stud receiving wrench for rotating said fastener.

2. The fastener of claim 1 wherein said shank has an upper cylindrical portion and a lower cylindrical portion.

3. The fastener of claim 2 wherein said lower cylindrical portion has threads thereon.

4. The fastener of claim 1 wherein said drive stud is hexagonal in shape.
